(19) United States
(12) Patent Application Publication
(10) Pub. No.: US 2019/0322530 A1
(43) Pub. Date: Oct. 24, 2019

(54) METHOD FOR THE PREPARATION OF CALCIUM MONOHYDROGEN PHOSPHATE

(71) Applicant: PRAYON TECHNOLOGIES, Wauters (BE)

(72) Inventors: Tibaut THEYS, Faulx-Les-Tombes (BE); Thomas HENRY, Heers (BE)

(73) Assignee: PRAYON TECHNOLOGIES, Engis (BE)

(21) Appl. No.: 16/311,626

(22) PCT Filed: Jun. 27, 2017
(86) PCT No.: PCT/EP2017/065857

§ 371 Date: Dec. 19, 2018

(30) Foreign Application Priority Data
Jun. 28, 2016 (BE) 2016/5485

(51) Int. Cl. C01B 25/32

(52) U.S. Cl. CPC C01B 25/324; A23L 33/16

(57) ABSTRACT

This present invention disclosure relates to a method for the preparation of calcium monohydrogen phosphate comprising an etching in an aqueous medium, during a predetermined time period, of a phosphate source with an acid with formation of a pulp comprising an aqueous phase containing calcium phosphate in solution and a solid phase containing impurities, a first separation between said aqueous phase and said solid phase, during a predetermined time period, a neutralization of said aqueous phase at a sufficient pH to obtain a precipitation of said calcium monohydrogen phosphate, a second separation between said aqueous medium and said calcium monohydrogen phosphate, characterized in that said first separation of said step b) is carried out at a filtration rate of at least 0.1 ton of P₂O₅/√ΔP/m²/day.

This invention relates to a method for the preparation of calcium monohydrogen phosphate or dicalcium phosphate comprising the steps of:

a) digestion in an aqueous medium, during a predetermined time period, of a phosphate source by an acid with formation of a pulp comprising an aqueous phase containing calcium phosphate in solution and a solid phase containing impurities,

b) a first separation between said aqueous phase containing calcium phosphate in solution and said solid phase containing impurities, for a predetermined time period,

c) a neutralization of said aqueous phase containing calcium phosphate in solution at a sufficient pH to obtain a precipitation in an aqueous medium of insoluble calcium phosphate as aforementioned calcium monohydrogen phosphate, and

d) a second separation between said aqueous medium and said calcium monohydrogen phosphate.

The etching of a phosphate source, such as phosphate ore, by an acid has been known for many years, for example U.S. Pat. No. 3,304,157 and GB 105 15 21 patents.

Document WO 2004002888 discloses a method for the manufacture of calcium monohydrogen phosphate (DCP) and also a method for the production of phosphoric acid from DCP obtained by the method described in this patent document.

This document provides for an etching of a phosphate ore in a digestion tank by a hydrochloric acid solution, having a concentration of about 5% by weight, to form a pulp comprising an aqueous phase containing calcium phosphate and chloride ions in solution and a solid phase containing impurities.

The passage of the aforementioned pulp through a filter press allows to separate the aqueous phase containing calcium phosphate and chloride ions in solution from the solid phase containing impurities.

A neutralization of the separate aqueous phase containing calcium phosphate and chloride ions is carried out by adding a calcium compound to precipitate the insoluble DCP in the aqueous phase following a pH rise.

Additional separation is performed to recover a wet DCP cake at the end of the method.

Regarding the production of phosphoric acid using the DCP thus obtained, it is carried out by liquid-liquid extraction and requires several implementation steps.

Indeed, it is necessary to carry out a solubilisation step of the wet DCP cake, obtained according to the method described above, by a new etching with more concentrated hydrochloric acid that can go up to 20% by weight. This solubilisation allows the formation of an aqueous solution containing phosphate ions, calcium ions and chloride ions, to be extracted by an organic extraction agent.

More precisely, this extraction step is carried out in an extraction column using an organic solvent and allows to produce an aqueous extraction phase containing chloride ions and calcium ions and an organic extraction phase containing phosphoric acid.

The organic extraction phase containing phosphoric acid is re-extracted using an aqueous re-extraction agent to isolate an aqueous re-extraction phase containing phosphate ions.

Finally, a concentration of the aqueous re-extraction phase allows the formation of a phosphoric acid aqueous solution.

This phosphoric acid production method is complex and requires several expensive steps to provide phosphoric acid of sufficient quality for the intended applications.

In addition, the use of organic extraction solvents makes such a method unattractive in terms of ecological impact.

Document WO 2005 066 070 refers to a method for etching phosphate ore with an aqueous hydrochloric acid solution having an HCl concentration of less than 10% by weight, with formation of a pulp consisting of an aqueous phase containing calcium phosphate solution and chloride ions and an insoluble solid phase containing impurities.

A neutralization of the aforementioned aqueous phase is carried out at a first pH at which a significant proportion of calcium phosphate is maintained in the aqueous phase in order to precipitate impurities.

Then, the aforementioned insoluble solid phase is separated from the aqueous phase while the precipitated impurities are isolated.

An additional neutralization of the aqueous phase is carried out at a second pH higher than the aforementioned first pH to precipitate DCP which is then separated from the aqueous medium.

This method is limited by the fact that an aqueous solution of hydrochloric acid having a concentration of less than 10% by weight must be used.

More recently, a method for etching a phosphate source with an aqueous hydrochloric acid solution was the subject of patent application WO 2015 082 468.

According to this disclosure, the digestion of the rock in the presence of the aqueous hydrochloric acid solution allows to form a pulp consisting of an aqueous phase containing calcium phosphate and chloride ions in solution, and an insoluble solid phase containing impurities.

The aqueous phase is then separated from the solid phase by filtration so that the aqueous phase can be neutralized to a sufficient pH in order to form an aqueous medium comprising chloride ions and in order to precipitate calcium phosphate in the form of said phosphate salt. Subsequent separation allows the phosphate salt to be isolated.

According to this method, the etching and filtration steps are carried out at a temperature of between 50° C. and 70° C. and the first aqueous solution of hydrochloric acid has a HCl concentration of less than or equal to 15% by weight.

Unfortunately, the known methods are impractical for industrialists because they do not have a sufficient extraction yield of P₂O₅ compared to the quantity of P₂O₅ present in the starting phosphate source and the phosphate salt obtained is not sufficiently pure, which nevertheless determines its potential use in several application fields, such as agriculture or food industry and high added value technical applications.

There is therefore a real need to provide a method for manufacturing calcium monohydrogen phosphate that ultimately solves this problem related to the calcium monohydrogen phosphate purity, while limiting P₂O₅ losses in waste generated by the method in order to improve the overall performances of the method.

The purpose of the invention is to provide a method for the manufacture of calcium monohydrogen phosphate that can be simpler to implement and reliable, while taking due account of the compromise between the desired degree of purity of the calcium monohydrogen phosphate obtained at the end of the method, the limitation of P₂O₅ losses and the duration of the method.

To solve this problem, according to the invention, a method is provided as indicated at the beginning, wherein said first separation of said step b) is carried out at a filtration rate of at least 0.1 ton of P₂O₅/√ΔP/m²/day, preferably between 0.1 and 5 tons of P₂O₅/√ΔP/m²/day, more preferably between 0.15 and 3 tons of P₂O₅/√ΔP/m²/day, more preferably between 0.3 and 0.9 tons of P₂O₅/√ΔP/m²/day, in particular between 0.4 and 0.7 tons of P₂O₅/√ΔP/m²/day, said filtration rate being calculated according to the following equation:

$$Filtration rate = \frac{{Q}_{P 2 O 5}}{\sqrt{Δ P} Ω {T}_{f}}$$

where

Q_{P205} corresponds to the quantity of P₂O₅ collected in the filtrate and is expressed in tons,

Ω is the filter surface area expressed in m²,

ΔP is the difference between the pressure at the filtrate outlet and the pressure applied to the pulp at the time of said first separation and is expressed in bar, and

T_{f} is the duration of said first separation and is expressed in day.

The filtration rate indicated above is calculated, in a known manner to the person skilled in the art, as described in particular in Albert Rushton, Anthony S. Ward and Richard G. Holdich, Solid-Liquid Filtration and Separation Technology, p. 35-93, ed. John Wiley & Sons, 2008.

Surprisingly, it appeared that it was possible to obtain in a simple way a P₂O₅ extraction efficiency for steps a and b greater than 90% by weight, preferably greater than 93% by weight, advantageously greater than 95% by weight, by applying fast and economical filtration rates on an industrial scale.

It has been found that the method according to the invention allows to carry out said step b) of first separation at a filtration rate which is particularly advantageous in that it allows, at the same time, to reduce filtration durations while not increasing the size of the filter, which is required for an industrial application.

Said predetermined time period of said step a) of digestion may be greater than, less than or equal to that of the aforementioned first separation step b).

It appeared particularly advantageous that the first separation step is no longer restrictive for the user since it is fast and efficient. This has the consequence that the method according to this invention is sufficiently profitable since it does not require repeated washing and consequent separation means.

In practice, whether in a continuous or discontinuous process, these advantages provided by the method significantly reduce the filtration surface area required. Thus, the first separation step is simpler and more efficient, which ultimately results in a more cost-effective method than the known prior art methods.

As explained, the calcium monohydrogen phosphate obtained by the method of this invention may be used in the agriculture sector, the food industry or in a composition for agriculture or food. The agriculture sector includes nutrients, such as fertilizers. It may also be used for the production of phosphoric acid.

Advantageously, the aforementioned steps a) and b) are carried out in a predetermined duration of less than 2 hours, preferably a duration between 30 and 100 minutes, preferably between 30 and 70 minutes, more preferably between 40 and 65 minutes.

More advantageously, said predetermined time period of said step a) is advantageously between 75 and 100 minutes, preferably between 80 and 95 minutes, or between 20 and 45 minutes, in particular between 24 and 40 minutes, preferably between 30 and 35 minutes.

According to a preferred embodiment, said phosphate source and said acid are introduced into a first reactor comprising said aqueous medium simultaneously or successively, in order to carry out said step a) of digestion and said pulp comprising said aqueous phase containing calcium phosphate in solution and said solid phase containing impurities is transferred from the first reactor to a separation means for carrying out said first separation referred to in the aforementioned step b) of first separation.

More preferably, said separation means is located between said first reactor and a second reactor.

Even more preferably, said separation means is present in a second reactor into which said pulp comprising an aqueous phase containing calcium phosphate in solution and a solid phase containing impurities is introduced, to carry out said first separation referred to in the aforementioned step b).

In addition, said separation means may preferably be a filter selected from the group consisting of a rotary filter, preferably with tilting cell, a press filter, a belt filter, a drum filter.

According to a preferred embodiment, said acid is selected from the group consisting of hydrochloric acid (HCl), nitric acid, sulfuric acid, phosphoric acid and mixtures thereof.

Advantageously, said acid is an aqueous solution of acid, preferably hydrochloric acid, having an acid concentration of less than or equal to 15% by weight.

More preferably, steps a) and b) are carried out at a temperature of between 50° C. and 70° C., preferably equal to 60° C.

Preferably, said phosphate source is selected from the group consisting of phosphate rock, phosphate ore, secondary phosphate sources such as ash (e. g. from sewage sludge or bone or pig slurry) or mixtures thereof.

Advantageously, the neutralization step is carried out using a neutralization agent selected from the group consisting of calcium-based compounds such as calcium oxide or hydroxide, calcium carbonate and water-soluble calcium salts.

Other forms of embodiments of the method according to the invention are indicated in the attached claims.

This invention also refers to use of calcium monohydrogen phosphate obtained according to this invention to produce phosphoric acid.

Such phosphoric acid production may involve an etching of the calcium monohydrogen phosphate obtained with sulphuric acid.

Preferably, calcium monohydrogen phosphate obtained by the method according to this invention is used in the food industry or in the agricultural or horticultural sector.

Other embodiments of the use according to the invention are indicated in the attached claims.

Other characteristics, details and advantages of the method and use according to the invention will emerge from the description given below, without being limitated to it.

In the context of this invention, the expression “a digestion is carried out during a predetermined time period” must be understood as meaning that the digestion ends at the time when the first separation step is initiated, which corresponds to the time when the pulp is introduced into a separation means, such as a filter.

In the context of this invention, the expression “first separation carried out during a predetermined time period” must be understood as meaning that the duration related to this first separation is determined from the moment when the pulp to be filtered is introduced into a separation means, such as a filter.

According to a practical example, a phosphate ore and an aqueous solution of hydrochloric acid are introduced simultaneously or successively into an aqueous medium contained in a first reactor.

After digestion for a predetermined time period, a pulp is obtained in the first reactor and is introduced into a separation means in order to carry out step b) of first separation for a predetermined time period which may be less than that corresponding to step a) of digestion.

This separation means may be present in the first reactor or in a second reactor.

When the separation means is present in the first reactor, it may be in fluid communication with that reactor.

Thus, the predetermined digestion duration ends when the pulp is introduced into the separation means.

The separation means may also be present in a second reactor, possibly in fluid communication with the first reactor.

It is also possible to use a first reactor, a second reactor and a separation means that can be arranged between said first and second reactors so as to be in fluid communication with them.

In the context of this invention, the method may be carried out in a continuous or discontinuous manner.

The step of neutralization of said aqueous phase comprising calcium phosphate and chloride ions in solution, when the etching is carried out with hydrochloric acid, is carried out at a pH sufficient to precipitate calcium phosphate in the form of said calcium monohydrogen phosphate.

A second separation is provided between said aqueous medium comprising chloride ions and calcium monohydrogen phosphate so as to provide the calcium monohydrogen phosphate obtained by the method according to this invention.

The steps of neutralization and second separation are known to the person skilled in the art, in particular document WO 2015 082 468, which is incorporated by reference in this patent application.

### EXAMPLE 1

We start from a phosphate ore having the characteristics of the following table 1:

| | | | |
|---|---|---|---|
| Phosphate quantity | | 1000.0 | g |
| Humidity | 1.93% | 19.3 | g |
| CaO | 48.90% | 489.0 | g |
| P₂O₅ | 31.00% | 310.0 | g |

A quantity of 120.8 g of demineralized water is introduced into a beaker and then a quantity of 75 g of phosphate from Table 1 is added to the demineralized water, under agitation, to form a mixture. The beaker is then covered with a watch glass and the mixture is brought to a temperature of 60° C.

120.8 g of demineralised water is mixed with an aqueous solution of hydrochloric acid, which has a HCl concentration of 37%, in order to obtain 357.7 g of an aqueous solution of HCl at 12%. The latter is then added to the hot mixture of phosphate and demineralized water.

The digestion duration is measured from the time the dilute aqueous acid solution is added to the hot mixture containing phosphate and demineralized water.

The solution obtained after digestion is filtered, at a filtration temperature of 60° C., by means of a polyester fibre filter having a diameter of 90 mm and a thickness of 0.17 mm placed on a Buchner type equipment previously evacuated.

The filtration pressure used is 0.4 bar, which represents a driving pressure difference of 0.6 bar compared to the atmospheric pressure of 1 bar.

The filtration duration corresponds to the time required to obtain a wet cake from the pulp formed in the previous steps. After the filtration, the cake is subjected to a drying stage during which, the ambient air is sucked through the cake, the drying stage lasting 5 minutes. According to this first example of embodiment, the filtration duration is 5 minutes.

The weight of the wet cake obtained is then measured as well as the weight of the filtrate. The filtrates and the cake are then subjected to analysis.

The wet cake is then dried at a temperature of 60° C. and its weight, after drying, is also measured.

In this example, the digestion duration is 30 minutes and the filtration duration is 5 minutes, as shown in Table 2 below.

TABLE 2
Example 1

| | | |
|---|---|---|
| Starting phosphate quantity | 75 | grams |
| Quantity of aqueous solution of HCl at 12% | 357.7 | grams |
| Ore digestion temperature | 60° | C. |
| Digestion duration | 30 | minutes |
| Filtration temperature | 60° | C. |
| Filtration duration | 5 | minutes |

| | |
|---|---|
| Filtration rate | 1.3 tons of P₂O₅/ |
| | m²/√ΔP/day |

The P₂O₅ yield in the final product obtained at the end of the method after steps a and b is equal to 94.03%. The yield is calculated on the basis of the quantity of P₂O₅ present in the phosphate ore. It represents the percentage of P₂O₅ in the filtrate after the first separation step b in relation to this quantity.

### EXAMPLE 2

This example is performed under the same operating conditions as described in example 1, with the exception of the digestion duration being 45 minutes and the filtration duration being 5.5 minutes, as shown in table 3 below.

TABLE 3
Example 2

| | | |
|---|---|---|
| Starting phosphate quantity | 75 | grams |
| Quantity of aqueous solution of HCl at 12% | 357.7 | grams |
| Ore digestion temperature | 60° | C. |
| Digestion duration | 45 | minutes |
| Filtration temperature | 60° | C. |
| Filtration duration | 5.5 | minutes |

| | |
|---|---|
| Filtration rate | 1.1 ton of P₂O₅/ |
| | m²/√ΔP/day |

The P₂O₅ yield after steps a and b of the method is 93.02%.

### EXAMPLE 3

This example is performed under the same operating conditions as described in example 1, with the exception of the digestion duration being 60 minutes and the filtration duration being 4.75 minutes, as shown in Table 4 below.

TABLE 4
Example 3

| | | |
|---|---|---|
| Starting phosphate quantity | 75 | grams |
| Quantity of aqueous solution of HCl at 12% | 357.7 | grams |
| Ore digestion temperature | 60° | C. |
| Digestion duration | 60 | minutes |
| Filtration temperature | 60° | C. |
| Filtration duration | 4.75 | minutes |

| | |
|---|---|
| Filtration rate | 1.3 ton of P₂O₅/ |
| | m²/√ΔP/day |

The P₂O₅ yield in the product after steps a and b of the method is 93.16%.

### EXAMPLE 4

This example is performed under the same operating conditions as described in example 1, with the exception of the digestion duration being 90 minutes and the filtration duration being 2.33 minutes, as shown in Table 5 below.

TABLE 5
Example 4

| | | |
|---|---|---|
| Starting phosphate quantity | 75 | grams |
| Quantity of aqueous solution of HCl at 12% | 357.7 | grams |
| Ore digestion temperature | 60° | C. |
| Digestion duration | 90 | minutes |
| Filtration temperature | 60° | C. |
| Filtration duration | 2.33 | minutes |

| | |
|---|---|
| Filtration rate | 2.7 tons of P₂O₅/ |
| | m²/√ΔP/day |

The P₂O₅ yield in the product obtained after steps a and b of the method is 91.96%.

### EXAMPLE 5

This example is performed under the same operating conditions as described in example 1, with the exception of the digestion duration being 10.5 minutes and the filtration duration being 25 minutes, as shown in Table 6 below.

TABLE 6
Example 5

| | | |
|---|---|---|
| Starting phosphate quantity | 75 | grams |
| Quantity of aqueous solution of HCl at 12% | 357.7 | grams |
| Ore digestion temperature | 60° | C. |
| Digestion duration | 10.5 | minutes |
| Filtration temperature | 60° | C. |
| Filtration duration | 25 | minutes |

| | |
|---|---|
| Filtration rate | 0.3 ton of P₂O₅/ |
| | m²/√ΔP/day |

The P₂O₅ yield in the product obtained after steps a and b of the method is 96.33%.

### EXAMPLE 6

This example is performed under the same operating conditions as those described in example 1, with the exception of the digestion duration being 15 minutes and the filtration duration being 13 minutes as shown in Table 7.

TABLE 7
Example 6

| | | |
|---|---|---|
| Starting phosphate quantity | 75 | grams |
| Quantity of aqueous solution of HCl at 12% | 357.7 | grams |
| Ore digestion temperature | 60° | C. |
| Digestion duration | 15 | minutes |
| Filtration temperature | 60° | C. |
| Filtration duration | 13 | minutes |

| | |
|---|---|
| Filtration rate | 0.5 ton of P₂O₅/ |
| | m²/√ΔP/day |

The P₂O₅ yield in the product obtained after steps a and b of the method is 96.19%.

### EXAMPLE 7

This example is performed under the same operating conditions as described in example 1, with the exception of the digestion duration being 21.5 minutes and the filtration duration being 9 minutes, as shown in Table 8 below.

TABLE 8
Example 7

| | | |
|---|---|---|
| Starting phosphate quantity | 75 | grams |
| Quantity of aqueous solution of HCl at 12% | 357.7 | grams |
| Ore digestion temperature | 60° | C. |
| Digestion duration | 21.5 | minutes |
| Filtration temperature | 60° | C. |
| Filtration duration | 9 | minutes |

| | |
|---|---|
| Filtration rate | 0.7 ton of P₂O₅/ |
| | m²/√ΔP/day |

The P₂O₅ yield in the product obtained after steps a and b of the method is 96.09%.

### EXAMPLE 8

This example is performed under the same operating conditions as described in example 1, with the exception of the digestion duration being 26.33 minutes and the filtration duration being 7.33 minutes, as shown in Table 9 below.

TABLE 9
Example 8

| | | |
|---|---|---|
| Starting phosphate quantity | 75 | grams |
| Quantity of aqueous solution of HCl at 12% | 357.7 | grams |
| Ore digestion temperature | 60° | C. |
| Digestion duration | 26.33 | minutes |
| Filtration temperature | 60° | C. |
| Filtration duration | 7.33 | minutes |

| | |
|---|---|
| Filtration rate | 71.8 tons of P₂O₅/ |
| | m²/√ΔP/day |

The P₂O₅ yield in the product obtained after steps a and b of the method is 95.85%.

It is understood that this invention is in no way limited to the embodiments described above and that many amendments may be made to it without going beyond the scope of the attached claims.

1. A method for the preparation of calcium monohydrogen phosphate comprising the steps of:
a) digesting in an aqueous medium, during a predetermined time period, a phosphate source by an acid with formation of a pulp comprising an aqueous phase containing calcium phosphate in solution and a solid phase containing impurities,
b) separating said aqueous phase containing calcium phosphate in solution and said solid phase containing impurities, for a predetermined time period to provide a separated aqueous phase containing calcium phosphate in solution,
c) neutralizing said separated aqueous phase containing calcium phosphate in solution at a sufficient pH to obtain a precipitation in an aqueous medium of insoluble calcium phosphate as aforementioned calcium monohydrogen phosphate, and
d) separating said aqueous medium and said calcium monohydrogen phosphate,
wherein step b) is carried out at a filtration rate of at least 0.1 ton of P₂O₅/√ΔP/m²/day, between 0.1 and 5 tons of P₂O₅/√ΔP/m²/day, between 0.15 and 3 tons of P₂O₅/√ΔP/m²/day, between 0.3 and 0.9 tons of P₂O₅/√ΔP/m²/day, or between 0.4 and 0.7 tons of P₂O₅/√ΔP/m²/day, said filtration rate being calculated according to the following equation:
$$Filtration rate = \frac{{Q}_{P 2 O 5}}{\sqrt{Δ P} Ω {T}_{f}}$$
where
Q_{P205} corresponds to the quantity of P₂O₅ collected in the filtrate and is expressed in tons,
Ω is the filter surface area expressed in m²,
ΔP is the difference between the pressure at the filtrate outlet and the pressure applied to the pulp at the time of said first separation and is expressed in bar, and
T_{f} is the duration of said first separation and is expressed in day.

2. The method according to claim 1, wherein said predetermined time period of said step a) of digestion is greater than, less than or equal to that of the aforementioned first separation step b).

3. The method according to claim 1, wherein the aforementioned steps a) and b) are carried out in a predetermined duration of less than 2 hours, between 30 and 100 minutes, 30 and 70 minutes, or between 40 and 65 minutes.

4. The method according to claim 1, wherein said phosphate source and said acid are introduced into a first reactor comprising said aqueous medium simultaneously or successively, in order to carry out said step a) of digestion and wherein said pulp comprising said aqueous phase containing calcium phosphate in solution and said solid phase containing impurities is transferred from the first reactor to a separation means for carrying out said first separation referred to in the aforementioned step b).

5. The method according to claim 4, wherein said separation means is located between said first reactor and a second reactor.

6. The method according to claim 4, wherein said separation means is present in a second reactor into which said pulp comprising an aqueous phase containing calcium phosphate in solution and a solid phase containing impurities is introduced, to carry out said first separation referred to in the aforementioned step b).

7. The method according to claim 4, wherein said separation means is a filter selected from the group consisting of a rotary filter, a rotary filter with tilting cell, a press filter, a belt filter, a drum filter.

8. The method according to claim 1, wherein said acid is selected from the group consisting of hydrochloric acid (HCl), nitric acid, sulfuric acid, phosphoric acid and mixtures thereof.

9. The method according to claim 8, wherein said acid is an aqueous solution of acid having an acid concentration of less than or equal to 15% by weight.

10. The method according to claim 1, wherein steps a) and b) are carried out at a temperature of between 50° C. and 70° C. or equal to 60° C.

11. The method according to claim 1, wherein said phosphate source is selected from the group consisting of a phosphate rock, a phosphate ore, and secondary phosphate sources.

12. The method according to claim 1, wherein the neutralization step is carried out using a neutralization agent selected from the group consisting of calcium-based compounds.

13. The calcium monohydrogen phosphate obtained according to claim 1, wherein the calcium monohydrogen phosphate is suitable for producing phosphoric acid.

14. The calcium monohydrogen phosphate obtained according to claim 1, wherein the calcium monohydrogen phosphate has a purity level suitable for use in the food industry in the agricultural sector, or horticultural sector.

15. The method according to claim 11, wherein the secondary phosphate sources are selected from ash, sewage sludge, bone slurry, pig slurry, or mixtures thereof.

16. The method according to claim 12, wherein said calcium-based compounds are selected from the group consisting of calcium oxide, calcium hydroxide, calcium carbonate, and water-soluble calcium salts.
